(19) United States
(12) Patent Application Publication
(10) Pub. No.: US 2007/0169713 A1
(43) Pub. Date: Jul. 26, 2007

(54) Livestock unloading system and method

(76) Inventors: Steven C. Sinn, Tremont, IL (US); Voris G. Feather, Tremont, IL (US); James Pyle, Harrodsburg, KY (US); Dennis R. Strickland, New Albany, IN (US)

Correspondence Address: COOK, ALEX, MCFARRON, MANZO, CUMMINGS & MEHLER LTD, SUITE 2850, 200 WEST ADAMS STREET, CHICAGO, IL, 60606, US

(21) Appl. No.: 11/337,731

(22) Filed: Jan. 23, 2006

(51) Int. Cl. B60P 3/04

(52) U.S. Cl. 119/406

(57) ABSTRACT

A livestock unloading system is provided including a livestock storage module including a partition system, a lifting device, and a conveyor positioning system. The lifting device includes a module engaging member and a module securing mechanism operatively associated therewith such that activation of the module securing mechanism causes the module engaging member to engage with a portion of the livestock storage module. The conveyor positioning system positions a livestock storage module in proximity to an unloader by hoisting the section of conveyor and livestock storage module situated thereon. A partition system for a livestock storage module section is further provided including a partition extending the general height of the module section. A linkage operatively couples a module section door with the partition, such that opening of the door causes movement of the partition.

### BACKGROUND OF THE INVENTION

The present invention relates generally to a system for handling livestock and more particularly to a system, means, device or apparatus to effect the efficient handling of livestock in the unloading of same from a transport vehicle to a farm site or processing plant.

It will be understood and appreciated that as the foregoing description of the present invention may be explained as it pertains to the handling of poultry, this description in no way shall be indicative of the limiting of “livestock” thereto.

Commercial poultry, such as turkeys, chickens, guineas, peafowl, ostriches, ducks, geese, swans and pigeons, have been one of man's main staples of protein throughout history. For centuries poultry was raised and processed on the farm and locally delivered to those who desired such fresh poultry. But as the population migrated to towns and cities, delivery of fresh poultry became increasingly difficult while the demand for processed poultry increased dramatically. In response to this need, fresh processed poultry now had to be transported to the markets located in these cities.

The poultry was customarily gathered manually at poultry houses, boxed or crated with numerous birds per crate, manually loaded aboard an open truck or van, and transported. The problems created by such a procedure were both numerous and significant. The manual handling of the poultry not only created a materially high cost involved in raising the poultry and preparing them for market, but it also created certain physical dangers to both the poultry as well as the workmen.

For example, during hand catching and subsequent handling of poultry, some birds are bruised, injured, or even killed due to a violent reaction of the birds or the unintentional rough handling by the workmen. Additionally, fowl inevitably beat their wings in an effort to escape upon capture, this would frequently result in a bird striking the handler with sufficient force to cause physical injury.

As technology was developed for the processing and safe storage of poultry, small processing plants developed and the manual loading and unloading of crates or coops began to improve. One of the first significant improvements, particularly in the turkey industry, was to create coops or crates which were permanently attached to a trailer or truck bed. These trucks contain large numbers of individual coops attached on the truck body. The coops having doors opening outward and being arranged in horizontal rows and vertical tiers. These coops or compartments typically having a permanent middle portion partition, and as such require loading from both sides of the truck. Not only is this time consuming, but loading from both sides also requires the trailer to turn around with all of its weight on one side thus causing an unsafe situation to driver, livestock, machinery and trailer.

The usual method of loading the poultry was to catch the animals individually and then lift and carry them to the coops while using makeshift platforms to reach the higher coops or to hand the birds to other workmen who are clinging to or standing on supports attached to the sides of the truck. The adult male turkey may weigh in excess of forty pounds, thus, any mishandling thereof causes a high incident of injuries to workers and animals alike, not to mention the considerable time requirements needed to accomplish the loading/unloading of a complete truck. The past thirty years have seen various conveyor belt apparatus designs to convey the poultry to the different heights of the vertical tier of coops. However, at the exit end of the conveyor belt, personnel still manually stuffed turkeys into compartments or coops. Thus, while such apparatus eliminated the laborious task of lifting animals to the different heights of coops in the vertical tier, the arduous task of stuffing the live poultry continued.

In light of preceding problems, there has been an effort in the art to develop a method of loading poultry for transport with a minimal amount of manual labor. For example, U.S. Pat. No. 5,902,089, issued May 11, 1999 describes a poultry loading apparatus for transporting poultry from a confinement area such as a poultry house to a transport vehicle to allow transport of poultry from farm-to-farm or from farm-to-processing plant. This is accomplished through the use of a base and a sectional mainframe defining a transport conveyance system. A section of the mainframe is pivotably attached to another section which is pivotably attached to the base. The apparatus further utilizes a control system for its overall leveling and pivotal height adjustments, as well as the extending/retracting capabilities of its conveyance.

Such a conveyance system certainly provides for an apparatus and system for loading poultry for transport that minimizes labor and costs while maximizing efficiency. However, when the fully loaded vehicle stops at its desired location, it must be unloaded. Although this conveyance apparatus is certainly capable of such unloading, it may be difficult to maneuver this apparatus within the typically less spacious area of a processing plant. In any event, the unloading process during the past two generations has not changed. The animals are manually grabbed and pulled out of the crates or coops and inverted on a shackle. Consequently, the animals are under high stress and typically react violently, thereby causing possible injury to themselves and/or the workers/employees. Thus, there exists a need for a poultry unloading apparatus and system that reduces labor costs and damaged product while increasing safety and efficiency.

Today, the poultry business is a multi-billion dollar industry. Large companies dominate the production, slaughter and marketing of products. Since poultry companies are now fewer in number, they therefore demand large quantities of animals daily for processing. In fact, enormous numbers of poultry are transferred daily from production facilities to the slaughter plant or to different production facilities en route to the slaughter plant.

With the advance of science and particularly the art of genetics the animals are becoming larger earlier in life. In fact, the average weight of a male turkey (for example) may exceed fifty pounds within the next five years. This requires a high demand for automation by the processors, and fundamental changes are now occurring as the production and processing consolidates. There will be more focus on creating, managing and tracking supply chains from the farm to the retail shelf that can elevate quality, consistency and demand responsiveness to previously unforeseen levels. At the same time, there is growing evidence that retailers (and ultimately consumers) are becoming increasingly proactive about the processes that generate the meat they are purchasing. More specifically, some consumers have become increasingly proactive with respect to the welfare of the animals they are consuming.

In view of the aforementioned needs and the shortcomings of the prior art, it is therefore an object of the present invention to provide a system that overcomes the deficiencies of the current practices whereby an apparatus and system is provided for unloading livestock for transport with a minimum amount of labor and with maximum efficiency at a minimum cost.

It is another object of the present invention to provide a livestock unloading system which maximizes efficiency and decreases damage to the animals during processing. It is another object of the present invention to provide a livestock unloading system which minimizes labor costs by reducing the number of employees as well as the turnover rate of employees.

It is yet another object of the present invention to provide a livestock unloading system whereby the manual and perhaps rough handling of the livestock is eliminated thereby improving overall animal quality by reducing animal stress and minimizing any damages sustained to the livestock. This reduction of stress decreases fecal contamination which in turn increases food safety.

Still another object of the present invention is to provide a user friendly livestock unloading apparatus that may be operated effectively by very few personnel.

Another object of the present invention is to provide an answer to the animal welfare conscious public regarding the handling of livestock.

Still another object of the present invention is to provide an unloading system that integrates tracking and/or data collection systems for the coop modules, trailers, transport vehicles and individual livestock.

These and other objects, features and advantages of the present invention will be clearly understood through a consideration of the following detailed description.

### SUMMARY OF THE INVENTION

According to the present invention, there is provided a lifting device for a livestock storage module including a module engaging member. A module securing mechanism is operatively associated with the module engaging member such that activation of the module securing mechanism causes the module engaging member to engage with a portion of the livestock storage module. In another aspect of the present invention, a method for transporting a livestock storage module is provided including positioning a lifting device near the livestock storage module and engaging a portion of the livestock storage module with said lifting device for transportation thereof.

A system for unloading livestock from a livestock module is further provided including a section of conveyor for carrying the livestock storage module. The section of conveyor is situated in proximity to an unloader. A hoist associated with the section of conveyor is also situated in proximity to the unloader and is adapted to position the section of conveyor and livestock storage module carried thereon in proximity to the unloader. In another aspect of the present invention, a method for unloading livestock is further provided including the steps of situating a livestock storage module on a section of conveyor and positioning the livestock storage module in proximity to an unloader by hoisting the section of conveyor and livestock storage module situated thereon.

A partition system for a livestock storage module section is further provided including a partition extending the general height of the module section. A linkage operatively couples a module section door with the partition, such that movement of the door causes movement of the partition.

### BRIEF DESCRIPTION OF THE DRAWINGS

The features of the present invention which are believed to be novel are set forth with particularity in the appended claims. The invention, together with the further objects and advantages thereof, may best be understood by reference to the following description taken in conjunction with the accompanying drawings, in the several figures of which like reference numerals identify like elements, and in which:

FIG. 1 is a field loading plan view of a livestock loading system including the loading apparatus and transport vehicle.

FIG. 2 is a perspective view of a transport vehicle in accordance with the principles of the present invention.

FIG. 3 is a rear view of the transport vehicle of FIG. 2.

FIG. 4 is a perspective view of a module of the transport vehicle in FIG. 2.

FIG. 5 is another perspective view of the module of FIG. 4.

FIG. 6 is a side view showing the partition of a coop in the module of the transport vehicle of FIG. 2.

FIG. 7 is a front view of the partition of FIG. 6.

FIG. 8 is a perspective view of a livestock unloading system including a lifting device for a livestock storage module in accordance with the principles of the present invention.

FIG. 9 is a perspective view of the lifting device of FIG. 8.

FIG. 10 is another perspective view of the lifting device of FIG. 8.

FIG. 11 is a side view of the module securing mechanism of the lifting device of FIG. 8.

FIG. 12 is a perspective view of an indicator of the lifting device of FIG. 8.

FIG. 13 is a perspective view of an indicator of the lifting device of FIG. 8.

FIG. 14 is a perspective view of a livestock unloading system including a hoist for positioning a livestock storage module in proximity to an unloader in accordance with the principles of the present invention.

FIG. 15 is a flow diagram or value stream map incorporating the principles of the present invention.

### DESCRIPTION OF THE PREFERRED EMBODIMENTS

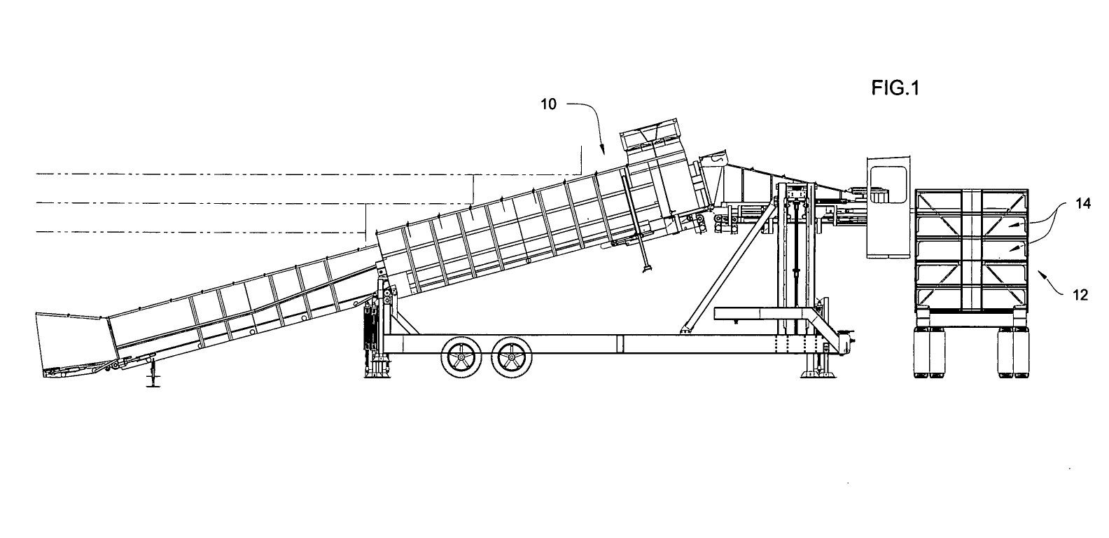

The present invention provides for a system of unloading livestock from a transport vehicle to a farm site or processing plant. As the livestock first require to be loaded upon the vehicle, FIG. 1 illustrates a livestock loading system much like the one disclosed in applicant's recently allowed U.S. patent application Ser. No. 10/044,675, and applicant's issued U.S. Pat. No. 6,447,234, both incorporated herein by reference. The system is shown in its operable state and includes a loading apparatus 10 perpendicular to a transport vehicle 12 having numerous rows of poultry (for example) coops 14. During loading, turkeys (for example) are telescoped by a plastic, steel or rubber conveyor belt into enlarged coops and gently placed on the coop floor. Once the loading process is complete, the transport vehicle 12 departs to eventually arrive at an unloading destination such as another farm or a processing plant.

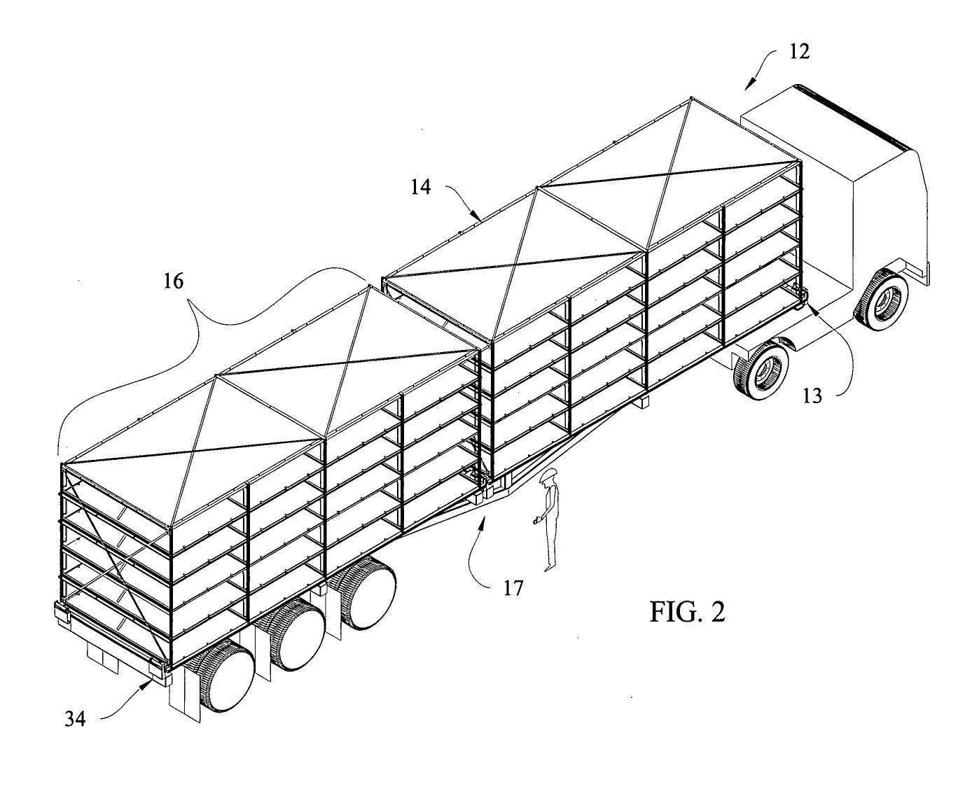

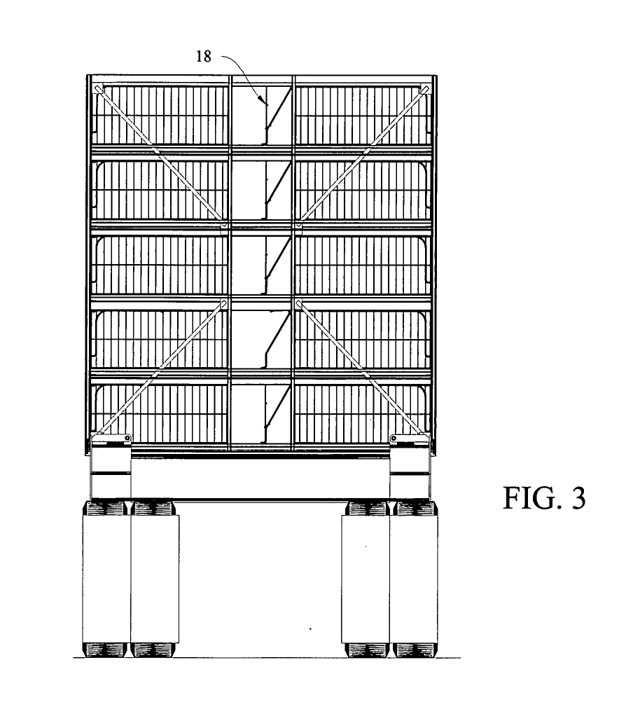

The present invention includes, among other things, a uniquely designed transport vehicle. FIGS. 2 and 3 generally illustrate the advantages of this transport vehicle design. In particular, FIG. 2 depicts a perspective view of the transport vehicle or trailer 12 showing how the transport units or coops 14, sometimes referred to as “racks” in the art, are arranged on the bed of the truck. The truck or trailer may be of conventional design or of a customized design. In this particular embodiment, there are 20 coops 14 per coop module 16. Removable panels (not shown) may further be included and stowed underneath the trailer at 17. FIG. 3 shows a partition 18 of the coops. This partition 18 is operable via a linkage with an associated coop door 22.

Each coop module 16 is secured on the coop trailer 12 via attachment members 13, which will be discussed in further detail below. The coop module 16 is secured onto the trailer in a semi-secure manner to allow the module to move slightly during transport. This movement helps to deter stress cracks on the module frame.

A standard coop trailer typically includes one hundred forty four coops per trailer, with each coop having a volume of about 16 cubic feet. This standard trailer requires the loading of one side of the trailer and turning the trailer around to load the opposite side. As such, the manual unloading process for turkeys entails personnel on both sides of the coop trailer physically grabbing/pulling and inverting the turkey to position its legs into a shackle. By contrast, the present system includes a coop trailer 12 with coops 14 having a volume of about 64 cubic feet. The swinging partition 18 of this trailer 12 allows the extension of the primary indexes of the unloading apparatus through the length of the coop (width of the transport vehicle), thus allowing the trailer to be completely unloaded and loaded from one side. This primary index extension arrangement is described in further detail in co-pending U.S. patent application Ser. No. 10/044,675. With fewer and larger coops, loading/unloading speeds can match processing plants line speed; and biosecurity and cleaning of coop modules are easier and require less time.

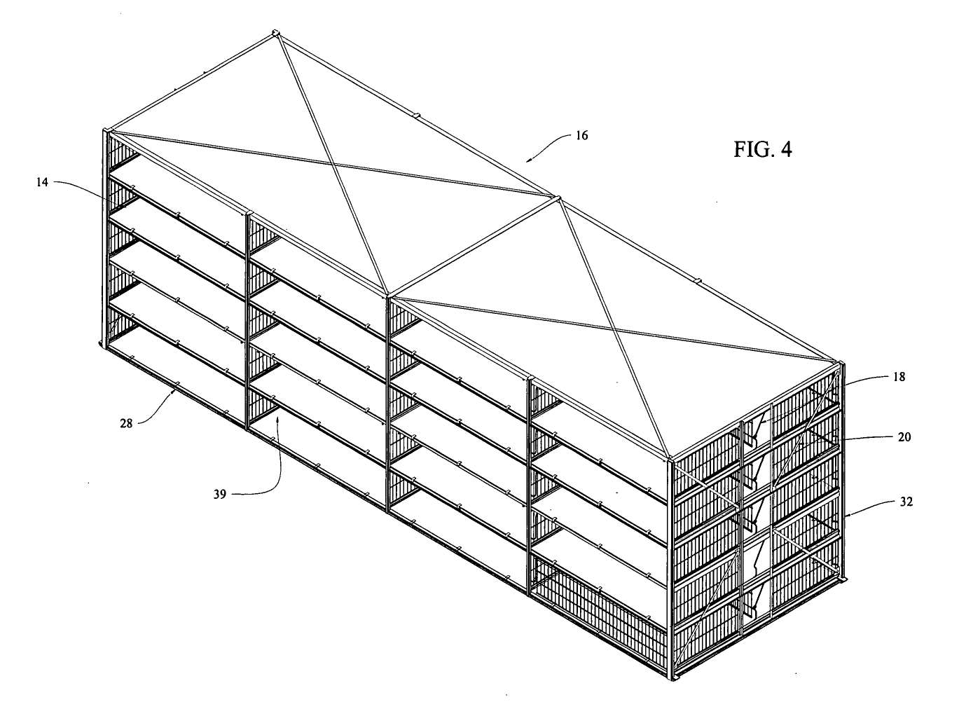

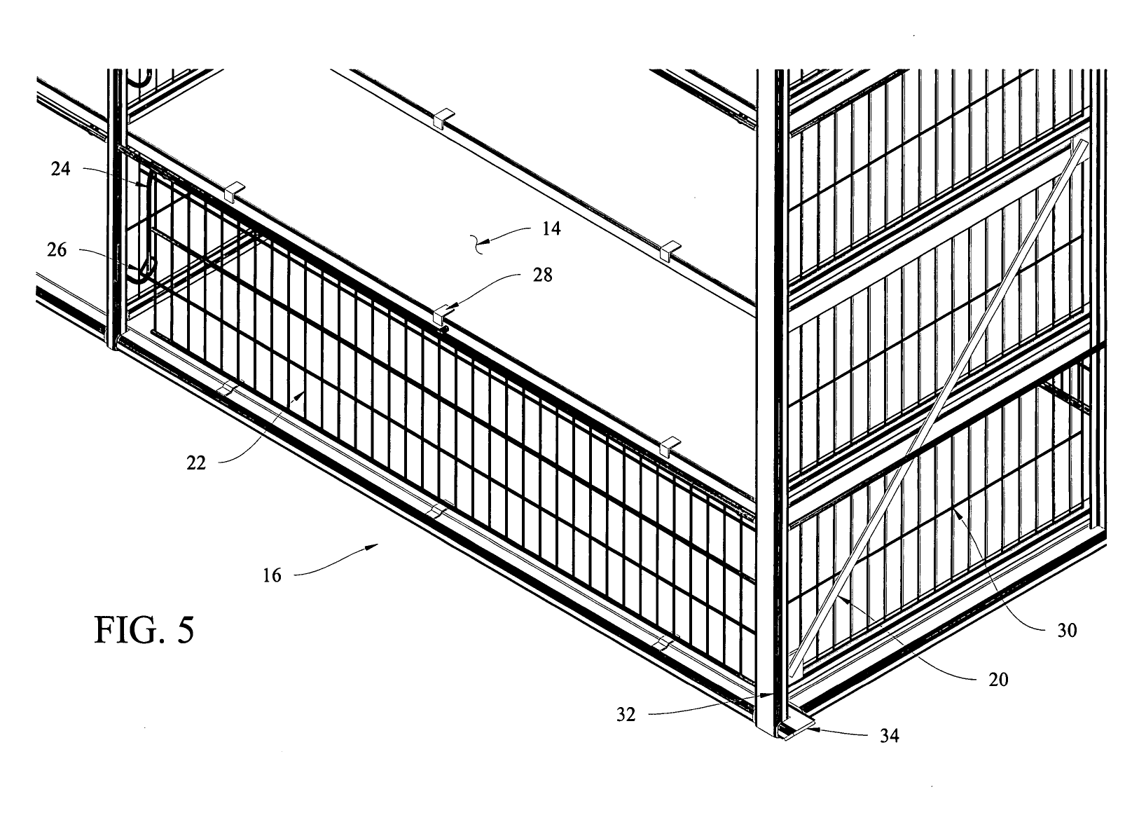

More particularly, an embodiment of the coop module 16 design of the present invention is illustrated in FIGS. 4 and 5. FIG. 4 shows a perspective view of the coop module 16 of the coop trailer 12. This particular module 16 has twenty openings on each side, one for each of the twenty coops 14. However, to reduce construction costs and to conform to different lengths and styles of trailers, modules may be built together or in single rows. Thus modules could have 10 to 40 coops instead of 10, with the possibility of any number of modules per trailer. The coops 14 have openings on either side to enable the telescoping section of the unloading apparatus to extend from either side of the trailer 12 and/or, depending upon field conditions and operator's preference, may also have additional linkage to allow both coop doors to activate the middle partition, thereby allowing the primary indexes of the loader/unloader to extend the complete length of the container. The configuration of the coop is adaptable to a multitude of trailer sizes. For example, a drop deck trailer can utilize five coops stacked on the top deck and six coops stacked on the drop deck. Such a configuration will increase the net hauling weight of the trailer, which in any event is dependent on particular state laws. Additionally, different trailers attached to the coop modules may enhance other safety features such as reducing the center of gravity and increasing stability. The module 16 of the preferred embodiment is currently 22 feet 6 inches wide, but may obviously vary depending upon the length of the trailer 12. Each module 16 is preferably braced for stability with members in the form of an “X” 20 as shown in FIG. 5.

The coop floor support, not shown, is currently a checkered pattern flat iron structure, while the coop floor is thin durable and washable plastic compound. The floor is slid into place from the side and held in place by metal tabs 28 or other means of securement. The floor may be more securely held atop the structure via screws in its middle, or rubber mounts attached above to allow the floor to flex to a minimal bend, particularly during the updraft wind pressure caused during transport without the livestock.

As shown in FIG. 5, the coop door 22 is constructed of thin steel bars in a checker pattern to both give it strength and allow the flexibility to bend while maintaining shape. A runner guide 24 or the like is positioned on both sides of the door currently consisting of a thin rod to side the door 22 opened and closed through the door's ringlets 26 or the like. To prevent any possible damage from the extension of the unloading apparatus, this guide is positioned roughly four inches off the floor. A hook or the like locks the door in the open position to prevent it from sliding down during loading/unloading and to prevent the animals from ensnaring themselves and/or dropping on personnel.

An additional mesh 30 is used for the sides of the coop 14. This mesh 30 is stationary and welded to the tubular steel frame 32 of the module. The size of the mesh is such that it allows free air movement yet small enough where animal parts cannot become entangled during transport and/or loading/unloading. This mesh or the doors may be enclosed by wooden or plastic panels or a flexible curtain (riot shown) during inclement weather. These panels or curtains may be stored under the trailer as previously shown in FIG. 1. Each module further includes an engaging device 34, otherwise known in the art as a “skid”, for attaching the module to the trailer via attachment member 13. This engaging device 34 may further serve as a conveyance structure on the chain conveyor as will be discussed in further detail below.

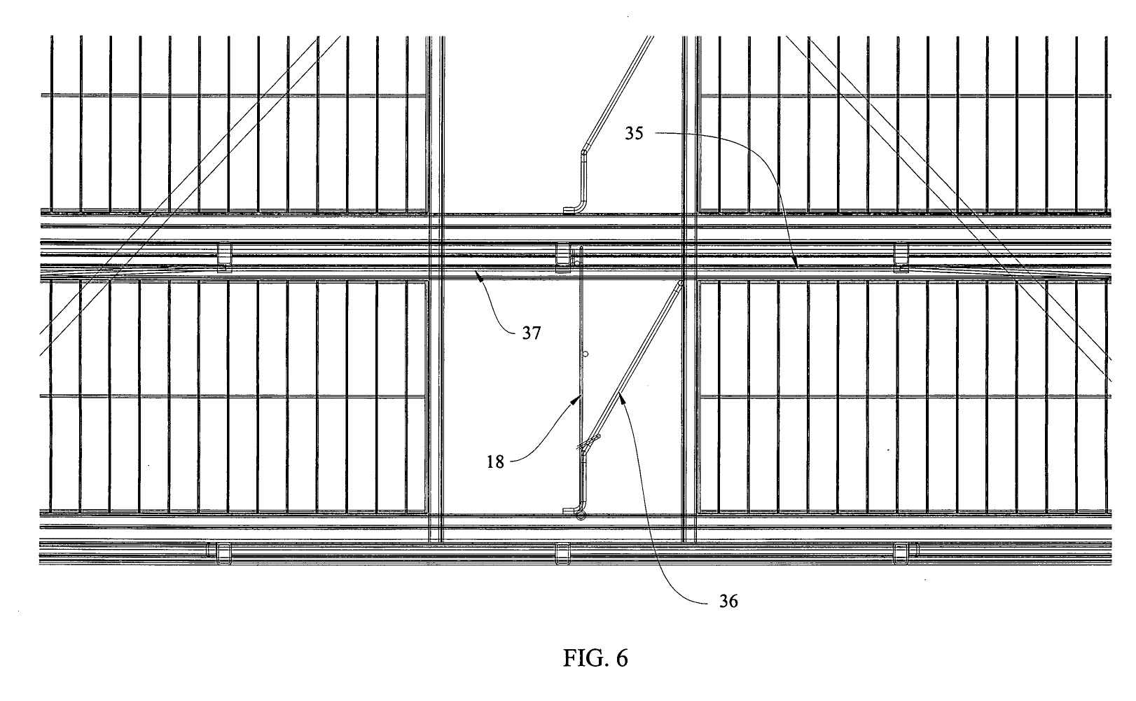

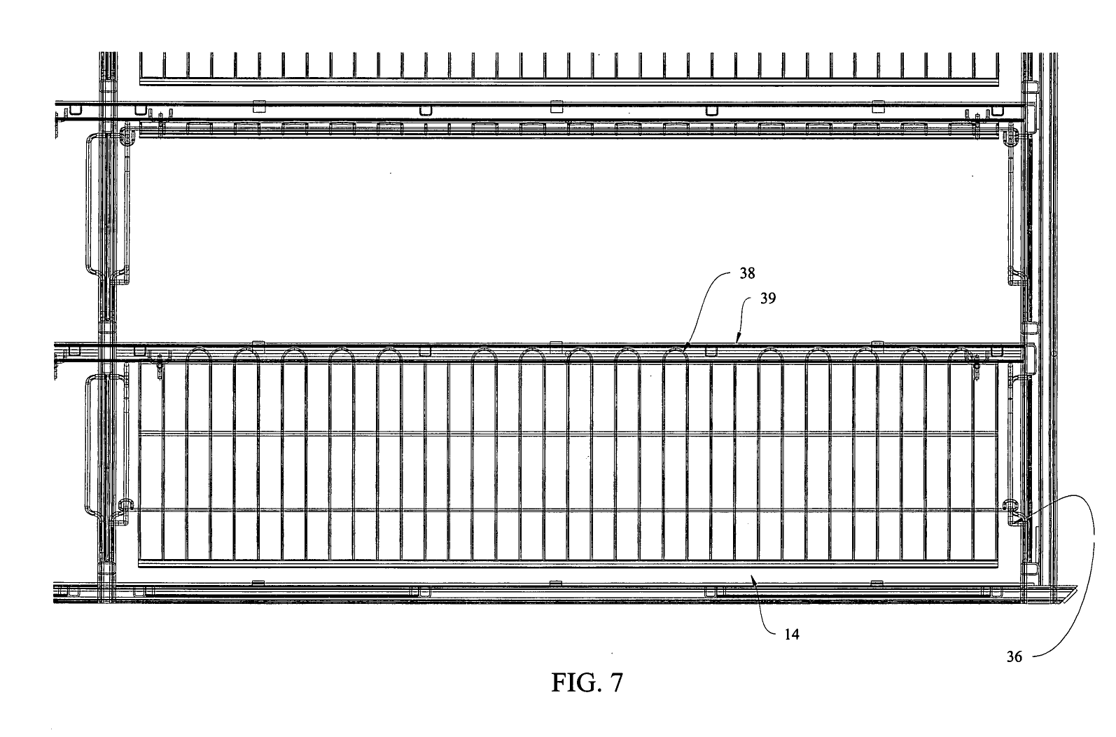

As shown in FIGS. 4, 6 and 7, the coop 14 of this embodiment further includes a partition 18 which may swing and lock in a generally perpendicular fashion. The partition is operatively coupled to the coop door such that partition raises when the operator opens the coop door during either the loading or unloading process. More specifically, as shown in FIG. 6 and 7, the partition 18 is operable via a linkage 37 with an associated coop door 22. When the coop door is opened, the linkage 37 is operatively coupled to the partition 18 such that the partition 18 slides up the side middle partition door runners 36. The top of the partition 18 rides on a support bar or hangar 35 which is propelled forward by the coop door linkage 37. Therefore, as the coop door is opened, the partition is pushed open. The partition 18 remains in an “up” position (parallel and generally adjacent to the ceiling of the coop) when the coop door is locked in an open position as discussed above. When the coop door is closed, the linkage 37 disengages the partition 18 causing the partition 18 to lower or drop and slide on the support hangar 35 via the force of gravity. Accordingly, the partition 18 would remain in the up position if there is no obstruction from the animal residing therein. It has been shown that during transportation, poultry settle in a crouch position, thus allowing the partition 18 to drop. The lowered partition aids in preventing the animals from shifting from side to side in the coop 14.

The partition 18 is generally situated in the middle of the coop and its structure serves to prevent the animal from shifting while inside the coop. More specifically, the partition 18 is situated such that it does not touch the floor 39 of the coop 14. The top portion of the partition 18 further includes a semicircular top portion or the like 38 and is further situated such that the semi-circular top portion 38 generally engages the ceiling 40 of the coop 14. This arrangement prevents the animals from shifting while inside the coop while further stopping them from entangling their limbs when the partition raises or lowers.

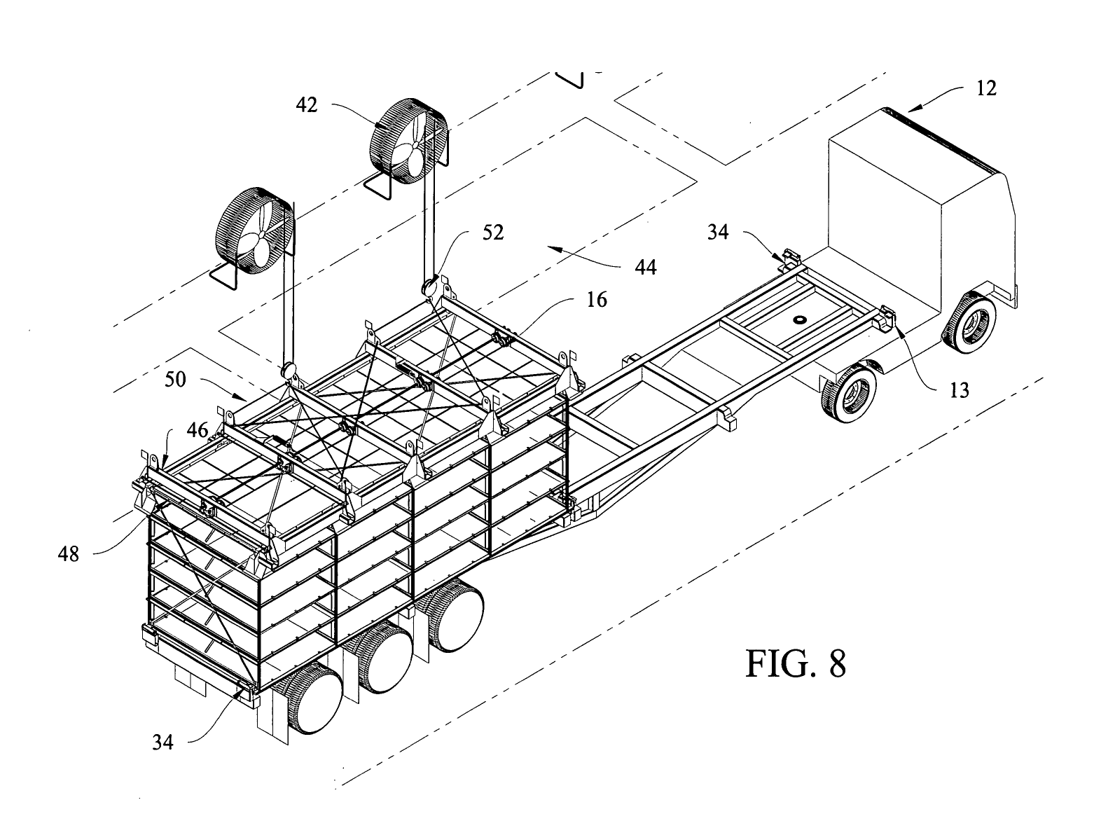

Now turning to FIG. 8, when a transport vehicle 12 reaches a destination employing one embodiment of the present invention, it is generally positioned near an unloader unit. Situated in general proximity to the unloader unit are fans 42, sprinklers, foggers and lighting to control the environmental conditions therewith. Each attachment member 13 is disengaged from an associated skid 34 such that each coop module 16 may be removed from the trailer via an overhead crane 44 including a coop module lifting device 46. The lifting device 46 engages the top portion 48 of the coop module 16 such that the module may be removed from the trailer and moved to an appropriate location. In this embodiment, the lifting device 46 includes a securing wire 50 generally designed to accommodate an overhead crane 44 via hooks 52. Although it may also be designed to accommodate other similar cranes or the like, a twin hoist overhead crane is used in this embodiment. As opposed to a single hoist crane, a twin hoist overhead crane is used in order to accommodate uneven weight distribution and thereby prevent tilting during raising and lowering the coop module 16.

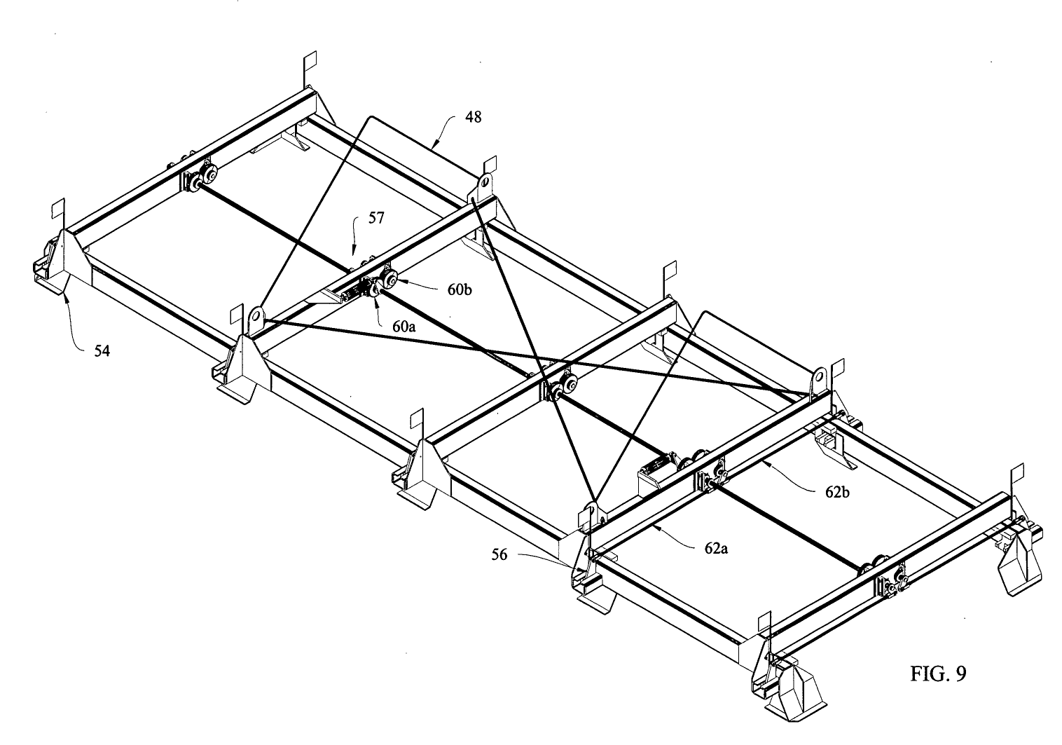

FIG. 9 illustrates the coop lifting device 46. Guide plates 54 are generally situated on the perimeter of the coop lifting device 46. These guide plates 54 aid in positioning the coop lifting device 46 in an appropriate location near the top portion 46 of the coop module 16. The coop lifting device 46 further includes a module engaging member 56 which operatively engages the top portion 48 of the coop module 16. Although, it may be designed in other comparable structures, the module engaging member in this embodiment is in the form of a pin. The coop lifting device 46 further includes a module securing mechanism 57 operatively associated with module engaging member 56.

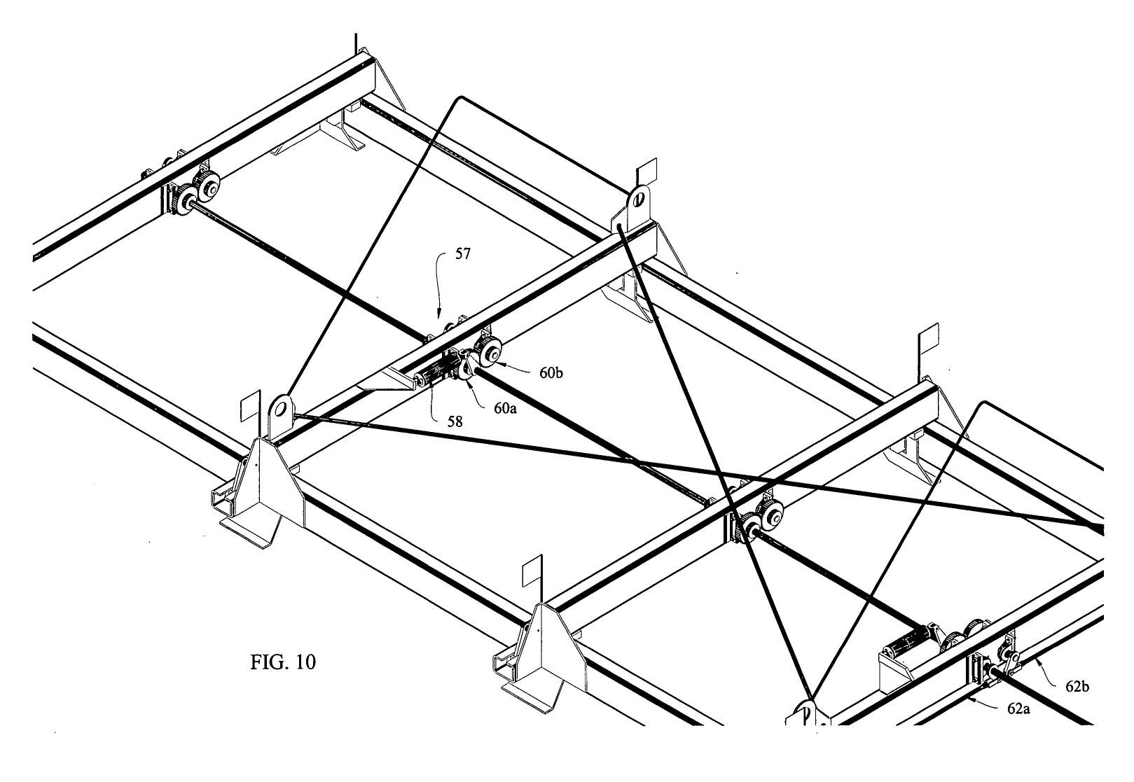

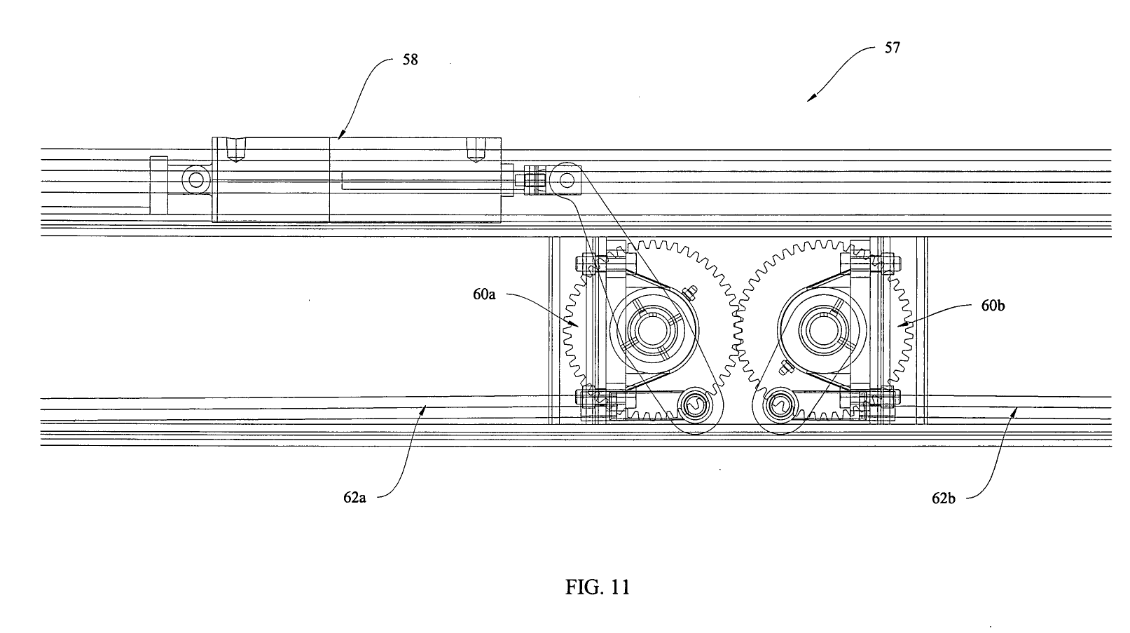

As shown in FIGS. 10 and 11, the module securing mechanism 57 includes an air cylinder 58. The air cylinder (or other power means) 58 is further associated with gears 60a, 60b which move associated rods 62a, 62b. In turn, these rods 62a, 62b are connected to the module engaging member 56 to engage and disengage the top portion 48 of the coop module 16. In this embodiment, when the air cylinder 58 is activated, an increase in air pressure in the air cylinder 58 causes the gears 60a, 60b to move the associated rods toward the outer perimeter of the coop module lifting device 46. In turn, this causes the connected module engaging member 56 to also move toward the outer perimeter of the coop module lifting device 46, thereby causing such to disengage from top portion 48 of the coop module 16. Alternatively, when the air cylinder 58 is charged from the other end, a decrease in air pressure in the air cylinder 58 causes the gears 60a, 60b to move the associated rods toward the center of the coop module lifting device 46. In turn, this causes the connected module engaging member 56 to also move toward the center of the coop module lifting device 46, thereby causing such to engage from top portion 48 of the coop module 16. The coop module engaging member 56 is spring loaded in case of a power outage or loss of air pressure so that the engaging mechanism does not unexpectantly release the coop module.

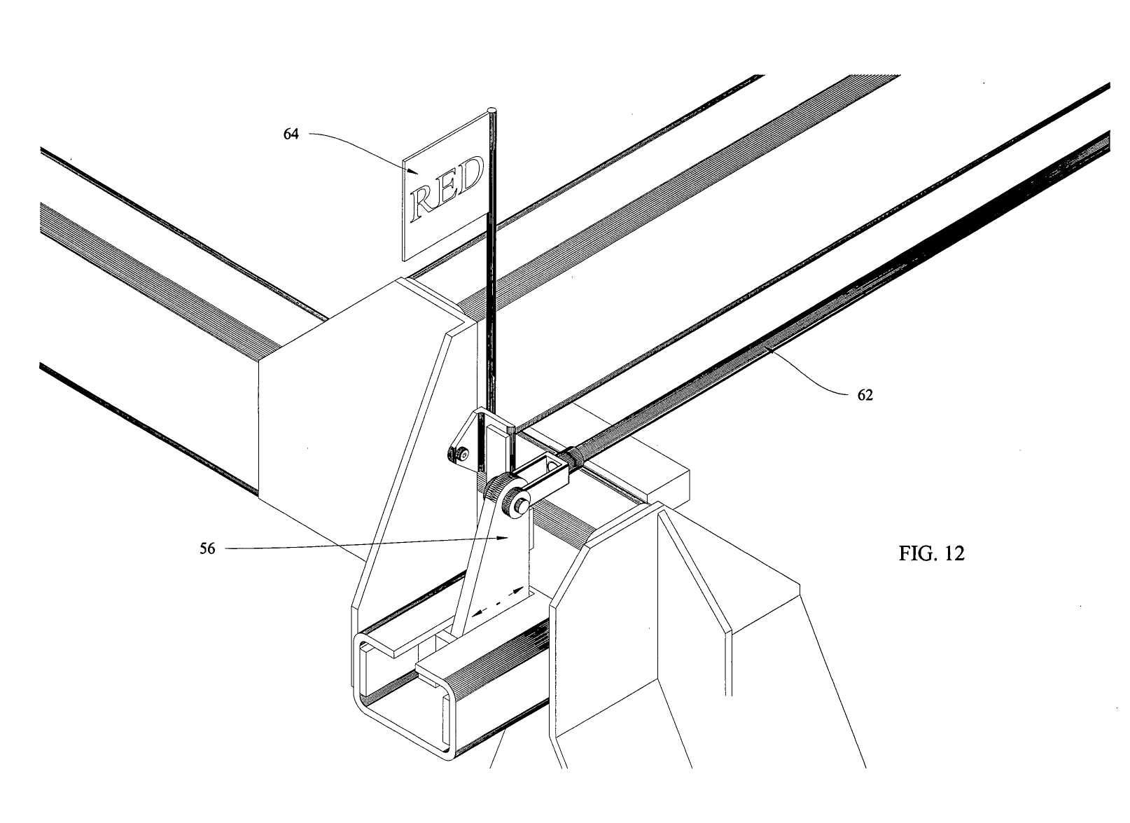

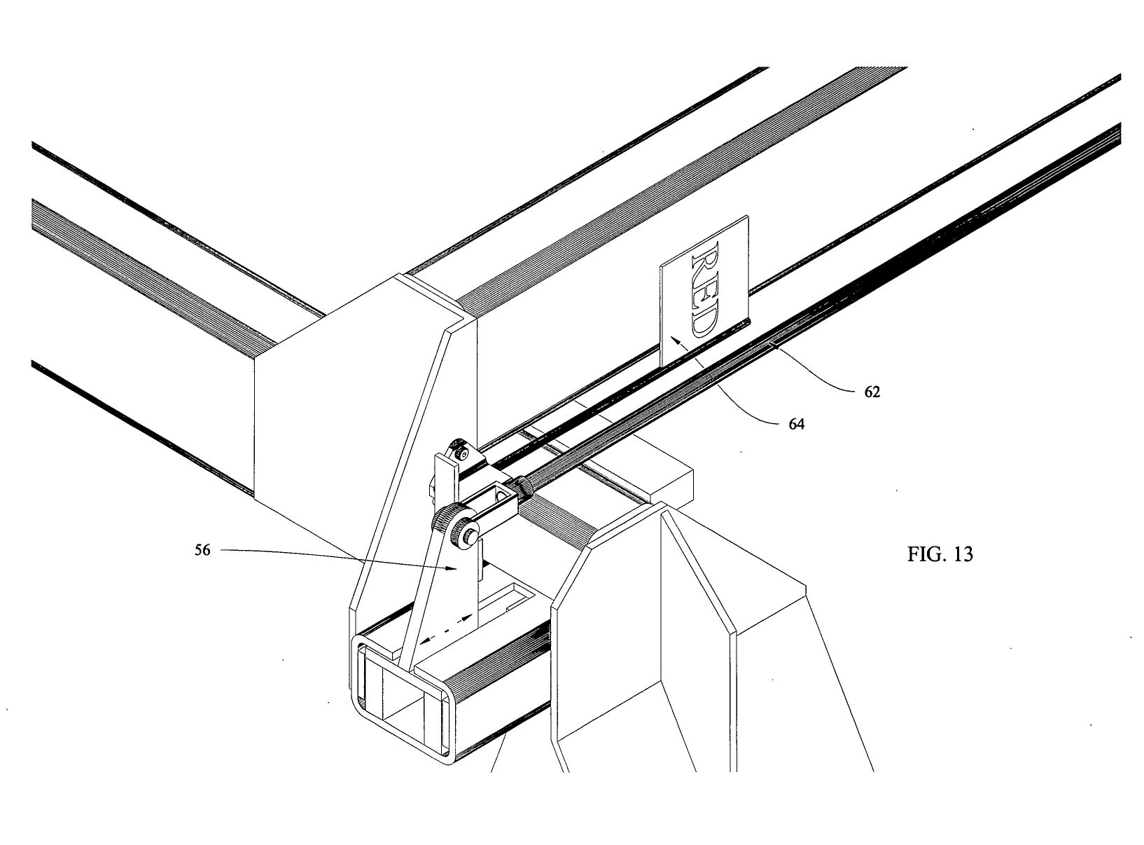

As shown in FIGS. 9, 12, and 13, further associated with each module engaging member 56 are indicators for signaling when the module engaging member 56 has substantially engaged the top portion 48 of the coop module 16. In this embodiment, the indicator includes a flag 64, which raises when the module engaging member 56 engages the top portion 48 of the coop module 16. Alternatively, the flag 64 lowers when the module engaging member 56 disengages the top portion 48 of the coop module 16.

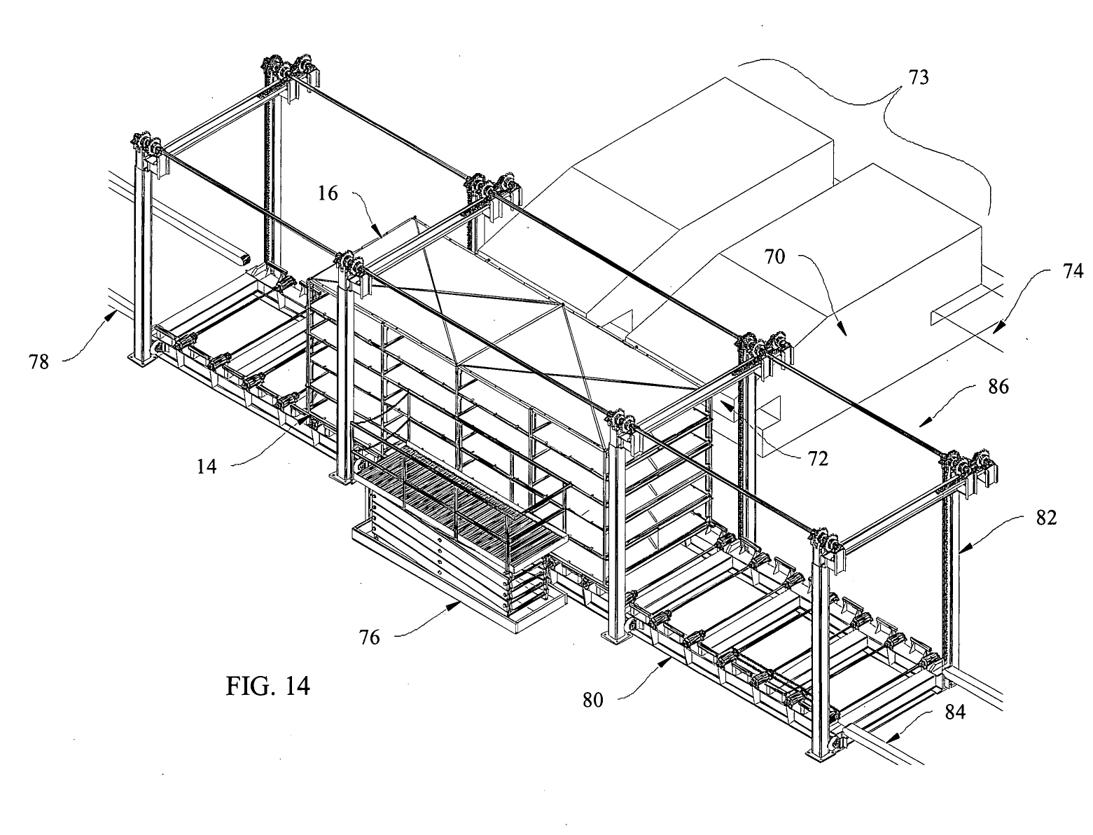

With the above mentioned lifting device 46, each coop module 16 may be removed from a trailer, moved, and placed near a base unloader unit 70. As shown in FIG. 14, primary indexes 72 extends from the base unloader 73 into the coop 14 in order to unload livestock. It is important to note that the primary index 72, may be raised, lowered, extended, or retracted. The primary index 72 is surrounded by a cleated plastic conveyor belt which when inserted into the coop 14, will pick the poultry up from the coop floor and transport them towards the base unloader unit 70 where they will be transferred onto a generally perpendicularly positioned discharge belt 74.

The base unloader 73 of the present embodiment unloads the livestock much like the unloader disclosed in applicant's recently allowed U.S. patent application Ser. No. 10/044,675, hereby incorporated herein by reference. More particularly, when the coop module 16 is positioned adjacent the unloader 73, at least one primary index 72 extends into a coop. It is important to note that the primary index is fully extendable into the coop and therefore enables the unloading of a coop module 16 from a single side without the need to re-position the coop module to unload from the other side. Once a coop is emptied of livestock, the primary index can be repositioned to empty the remaining column of coops. Once a full column of coops is emptied of livestock, the coop module may be repositioned on the conveyor 80 to empty the next column. Alternatively, the base unloader 73 may have multiple indexes and accordingly be capable of unloading more than one column and coop at a time.

Once the livestock leaves the coop module 16, they can be conveyed to an unloading station and/or a preshackle stunner before they are moved on to final processing. At the unloading station, individual livestock information may be gathered (i.e. weight, DOA, etc.) for later further analysis. The preshackle stunner may be of the typical CO2/O2, nitrogen, electric, and/or other means. Once these steps are complete, the livestock is ready for further animal processing.

Opposite the primary index 72 is a movable platform 76 to facilitate in the unloading process. By raising and lowering of this platform 76, an operator may easily access each coop. Accordingly, an operator helper may release a lodged animal and may further access each coop via opening the coop door to assist in the washing and disinfecting of the coop module. In addition, the operator can manually raise the partition 18 by inserting a hook and pulling the top 38 of the partition and temporarily lock the middle partition in the up position during the unloading process. In any event, during this process, the coop module 16 is further positioned on a coop module transfer conveyor 78. The section of conveyor 80 associated with the base unloader 74 and the coop module 16 situated thereon are raised and lowered, or otherwise moved away and toward the primary index 72 via a hoist 82, in order to facilitate the aforementioned unloading process.

The conveyor 80 has predetermined stops for the coop module to stop at a position for the primary index 72 to extend cleanly the length of the container for each column of the coop module. In addition, as base unloader units 70 are utilize, predetermined stops are designed for all columns of the coop module in case one or more base unloading units 70 primary indexes malfunctions. Synchronization component 86 insures a true vertical and descending motion of the coop module in relation to the base unloader units 70 primary indexes 72. This will allow for the primary index 72 to slide evenly over the coop floor 39 and preventing feathers or toes from being pinched. Means other than hydraulic cylinders could raise the conveyor 80 and other means could be implemented to maintain the conveyor vertically true to the base unloader unit primary indexes.

After unloading and processing, the coop module is conveyed to another section of the conveyor 84 for washing or disinfecting. The clean coop module may further be transferred back to a trailer via yet a lifting device similar to that described above.

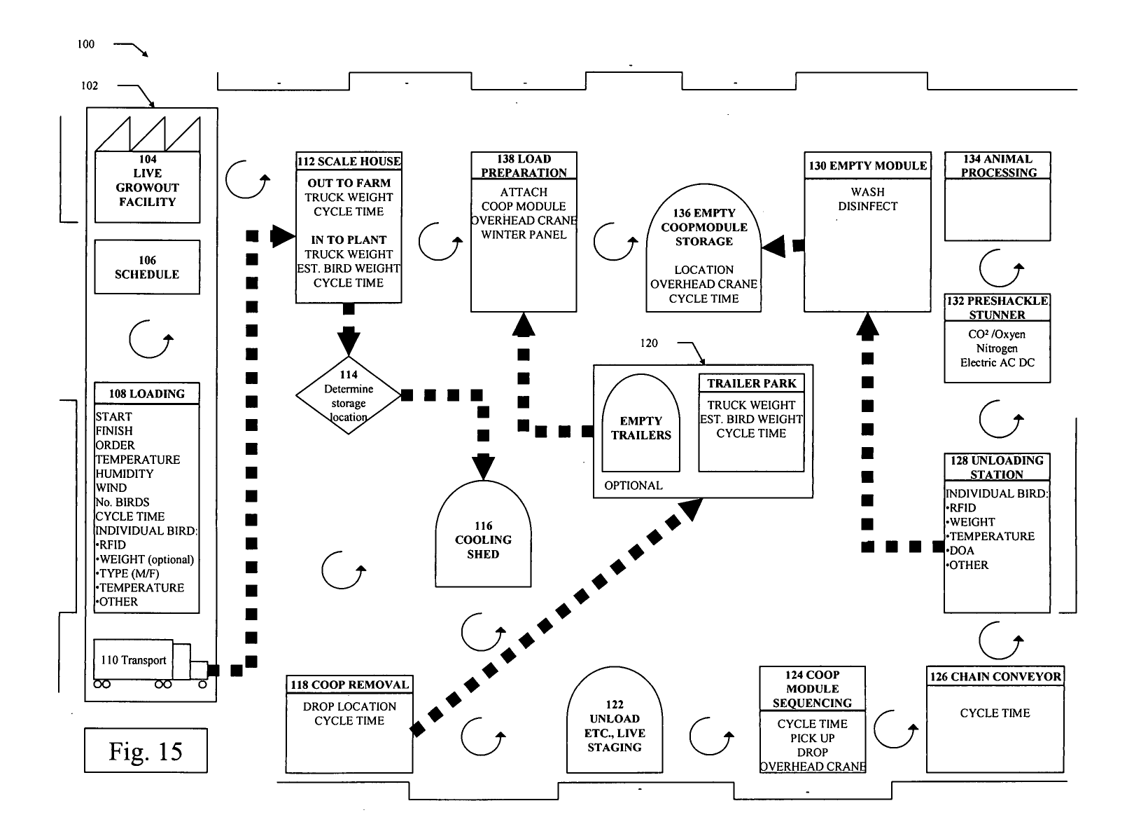

The flow diagram, or value stream map, of FIG. 15 is an example of a complete cycle of use 100 of the present invention from live growout facility to processing plant and back again. More particularly, the components of the value stream map of FIG. 15 show the flow of objects, whether they are livestock, coop modules, coop trailers, tractors, loaders/unloaders, etc., from point to point throughout the cycle. The flow before arrival at the scale house is shown within the pre-arrival process 102 and includes the live growout facility 104, scheduling 106, loading 108 and transport 110. Information about the transport is then gathered at the scale house 112 and used to determine the storage location 114 of the transport. This location is either a cooling shed or the like 116 or straight to coop removal 118.

Depending upon plant parameters, coop modules are removed from the trailer and the trailer may be stored at an optional trailer park 120 until such time as it is called to load preparation 138. In any event, the modules are moved to a staging area 122 before the overhead crane picks them up at module sequencing 124 and delivers them to the chain conveyor 126.

The unloading station 128 removes the livestock from the modules as described above and delivers the modules to the wash/disinfect area 130 and the livestock to the preshackle stunner area 132 and on to animal processing 134. After the modules are washed and disinfected at 130, they are stored 136 and perhaps serviced/repaired before they are attached back to a trailer at load preparation 138.

The present invention has also been designed for ease in tracking and data collection, and in particular takes into account the numerous advantages of radio frequency identification (RFID), for example. RFID is a system for tagging and identifying mobile objects (i.e. coop modules, coop trailers, semi-trailers, livestock, loaders and unloaders) so that they can be labeled and tracked as they move from place to place. Information can be attained through the use of RFID. At the loading station 108, for example, such personal animal information like weight and individual temperature, as well as other more general information like location, start time, finish time, temperature, humidity, barometric pressure, number of animals, etc. can be documented with the use of a personal digital assistant or other electronic recording/transmitting means or possibly non-electric means. Similarly, at the unloading station 128, the same information as well as other information (i.e. DOAs, body temperature and individual weight) can be documented. Theses types of tracking systems can take into account the possibility of future improvement of data gathering within the livestock itself that could collect/analyze information (i.e. hormone and enzyme levels, antibodies, specific animal traits, etc.).

While particular embodiments of the invention have been shown and described, it will be obvious to those skilled in the art that changes and modifications may be made therein without departing from the invention in its broader aspects, and, therefore, the aim in the appended claims is to cover all such changes and modifications that fall within the true spirit and scope of the invention.

1. A lifting device for a livestock storage module, comprising:
a module engaging member; and
a module securing mechanism operatively associated with said module engaging member, whereupon activation of said module securing mechanism causes said module engaging member to engage with a portion of the livestock storage module.

2. The lifting device of claim 1, further comprising an indicator operatively coupled to said module securing mechanism for signaling when said module engaging member has substantially engaged with a portion of the livestock storage module.

3. The lifting device of claim 2, wherein the indicator comprises a flag which raises when said module engaging member has substantially engaged with a portion of the livestock storage module.

4. The lifting device of claim 1, wherein the module engaging member is a pin.

5. The lifting device of claim 1, wherein the module securing mechanism includes an air cylinder, wherein when said air cylinder is charged from the other end, the air cylinder causes the module engaging member to engage a portion of the livestock storage module.

6. The lifting device of claim 1, further comprising a plurality of guide plates for guiding the positioning of the lifting device near the livestock storage module.

7. The lifting device of claim 1, further comprising a securing wire to accommodate an overhead crane.

8. A method for transporting a livestock storage module, comprising:
positioning a lifting device near the livestock storage module; and
engaging a portion of the livestock storage module with said lifting device for transportation thereof.

9. The method for transporting a livestock storage module of claim 8, further comprising unfastening the livestock storage module from a transport vehicle.

10. The method for transporting a livestock storage module claim 8, wherein engaging a portion of the livestock storage module includes deactivating a module securing mechanism in order to cause a module engaging member to engage with a portion of the livestock storage module.

11. The method for transporting a livestock storage module claim 8, wherein deactivating a module securing mechanism includes decreasing air pressure within an air cylinder which is operatively associated with a module engaging member to engage with a portion of the livestock storage module.

12. The method for transporting a livestock storage module claim 8, further comprising disengaging a portion of the livestock storage module with said lifting device for lifting thereof.

13. The method for transporting a livestock storage module claim 12, disengaging a portion of the livestock storage module includes activating a module securing mechanism in order to cause a module engaging member to disengage with a portion of the livestock storage module.

14. The method for transporting a livestock storage module claim 13, wherein activating a module securing mechanism includes increasing air pressure within an air cylinder which is operatively associated with a module engaging member to disengage with a portion of the livestock storage module.

15. The method for transporting a livestock storage module claim 8, further comprising indicating when a portion of the livestock storage module is engaged or disengaged with said lifting device.

16. The method for transporting a livestock storage module claim 15, wherein the indicating includes raising a flag when a portion of the livestock storage module is engaged with said lifting device and lowering a flag when a portion of the livestock storage module is disengaged with said lifting device.

17. The method for transporting a livestock storage module claim 8, wherein the positioning of said lifting device is achieved through a plurality of guide plates on said lifting device.

18. A system for unloading livestock, comprising:
a livestock storage module;
a section of conveyor for carrying said livestock storage module, said section of conveyor being situated in proximity to an unloader; and
a hoist associated with the section of conveyor situated in proximity to the unloader; said hoist adapted to position the section of conveyor and livestock storage module carried thereon in proximity to the unloader.

19. The system for unloading livestock of claim 18, further comprising another section of conveyor, wherein after unloading the livestock storage module is transported thereto.

20. The system for unloading livestock of claim 18, further comprising a lifting device for situating the livestock storage module onto the section of conveyor.

21. The system for unloading livestock of claim 19, further comprising a lifting device for transporting the livestock storage module from the other section of conveyor.

22. The system for unloading livestock of claim 18, further comprising a moveable platform in proximity to the section of conveyor for accessing the livestock storage module.

23. A method for unloading livestock, comprising:
situating a livestock storage module on a section of conveyor; and
unloading the livestock storage module by positioning said livestock storage module in proximity to an unloader by hoisting the section of conveyor and livestock storage module situated thereon.

24. The method for unloading livestock of claim 23, further comprising situating the livestock storage module on the section of conveyor via a lifting device.

25. The method for unloading livestock of claim 23, further comprising accessing the livestock storage module with a moveable platform situated in proximity to the section of conveyor.

26. The method for unloading livestock of claim 23, further comprising transferring the livestock storage module to another section of conveyor.

27. The method for unloading livestock of claim 23, further comprising transporting the livestock storage module to another location using a lifting device.

28. A partition system for a livestock storage module section, comprising:
a partition extending the general height of the module section;
a bracket operatively coupling a module section door with the partition, such that movement of said door causes movement of said partition.

29. The partition system of claim 28, wherein the partition includes a semi-circular top portion.

30. The partition system of claim 28, wherein the linkage is configured such opening said door causes the partition to raise.

31. The partition system of claim 28, wherein the linkage is configured such that closing said door allows the partition to lower.

32. The partition system of claim 31, wherein the linkage is configured such that closing said door allows the partition to lower via the force of gravity.

33. A system for unloading livestock, comprising:
a livestock transport container having multiple storage units, said container being adaptive to removably engage a transport vehicle, said units being generally rectangular with a top, a bottom, two sides and two ends, said sides of said unit generally extending said width of said container such that said ends are readily accessible from either of said sides;
a lift for removing said container from said vehicle and placing said container on a conveying system; and
a livestock unloader having an extending/retracting conveyor for removing livestock from said unit, said conveyor adapted to extend the width of said container.

34. A method of unloading livestock, comprising:
providing a plurality of livestock containers positioned on a transport vehicle;
lifting said containers from said vehicle to a first conveying system;
conveying said containers to a unloading station; and
unloading a storage unit of said container by extending a second conveying system from one side of said container to the other.

35. A method of unloading livestock, comprising:
loading livestock into removable modules on a transport vehicle;
transporting said livestock to a processing destination;
removing said module from said vehicle;
unloading said livestock from said module; and
attaching empty modules on said vehicle.

36. The method defined in claim 35, further comprising:
tagging said livestock with an RFID prior to loading; and
obtaining information from said RFID after unloading.

37. The method defined in claim 35, further comprising:
tagging said removable modules with an RFID prior to loading; and
obtaining information from said RFID after loading.

38. The method defined in claim 35, further comprising:
tagging said transport vehicle with an RFID prior to loading; and
obtaining information from said RFID after loading.

39. The method defined in claim 35, further comprising:
tagging one or more of the elements of the unloading system with an RFID prior to loading; and
obtaining information from said RFID after loading.
